(19) United States
(12) Patent Application Publication
(10) Pub. No.: US 2024/0354226 A1
(43) Pub. Date: Oct. 24, 2024

(54) Sandboxing Databases

(71) Applicant: MICRO FOCUS LLC, Santa Clara, CA (US)

(72) Inventors: Alexander Kalinin, Watertown, MA (US); Yuanzhe Bei, Marblehead, MA (US)

(73) Assignee: MICRO FOCUS LLC, Santa Clara, CA (US)

(21) Appl. No.: 18/305,990

(22) Filed: Apr. 24, 2023

(51) Int. Cl. G06F 11/36; G06F 16/27

(52) U.S. Cl. CPC G06F 11/3664; G06F 16/27

(57) ABSTRACT

A sandbox database is created. The sandbox database is typically a temporary database. For example, the sandbox database may be a test database for evaluating a new version of software. Creating the sandbox database comprises creating a sandbox cache in the sandbox database and copying metadata from a main database to the sandbox database. The sandbox cache is used to store record(s) that are accessed during the use of the sandbox database. The metadata is used to reference the record(s). This allows for a simpler process for creating a temporary database to be used for testing software.

### FIELD

The disclosure relates generally to database management and particularly to creating sandbox databases to provide a test environment for a database.

### BACKGROUND

Almost any real-world test environment for a database requires high availability, performance stability, and disaster recovery. A major change to a production system can potentially affect the production workload, which is essential to a business. In worst case scenarios, when bad changes occur, the production system can be degraded, can malfunction, and even crash. Having these kinds of problems is clearly not an acceptable solution.

### SUMMARY

These and other needs are addressed by the various embodiments and configurations of the present disclosure. The present disclosure can provide a number of advantages depending on the particular configuration. These and other advantages will be apparent from the disclosure contained herein.

A sandbox database is created. The sandbox database is typically a temporary database. For example, the sandbox database may be a test database for evaluating a new version of software. Creating the sandbox database comprises creating a sandbox cache in the sandbox database and copying metadata from a main database to the sandbox database. The sandbox cache is used to store record(s) that are accessed during the use of the sandbox database. The metadata is used to reference the record(s). This allows for a simpler process for creating a temporary database to be used for testing software.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for creating a sandbox database from a main database.

FIG. 2 is a block diagram of a second illustrative system that shows multiple sandbox databases being created for different purposes using a non-distributed main database.

FIG. 3 is a block diagram of a third illustrative system that shows multiple sandbox databases being created for different purposes where the main database is a replicated database.

FIG. 4 is a flow diagram of a process for replicating records from a main database to a sandbox database based on a request from the sandbox database using a metadata pull.

FIG. 5 is a flow diagram of a process for replicating records from a main database to a sandbox database based on a request from the sandbox database using a metadata push.

FIG. 6 is a flow diagram of a process for replicating records from a main database to a sandbox database based on a request from the main database using a metadata pull.

FIG. 7 is a flow diagram of a process for replicating records from a main database to a sandbox database based on a request from the main database using a metadata push.

FIG. 8 is a flow diagram of a process for creating a sandbox database.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

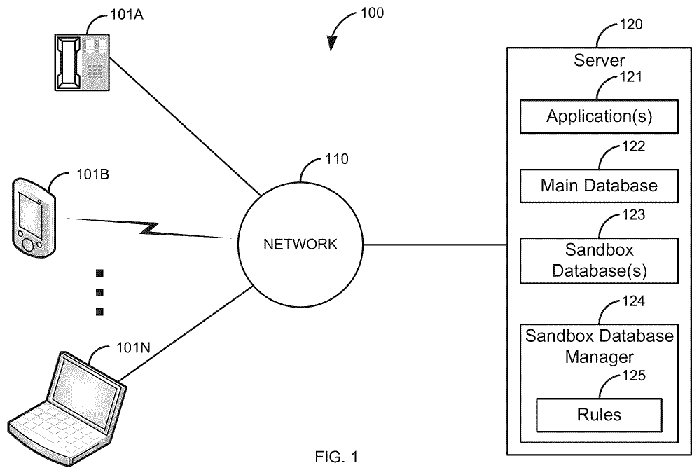

FIG. 1 is a block diagram of a first illustrative system 100 for creating a sandbox database 123 from a main database 122. The first illustrative system 100 comprises communication devices 101A-101N, a network 110, and a server 120.

The communication devices 101A-101N can be or may include any device that can communicate on the network 110 and access the databases 122 and/or 123, such as a Personal Computer (PC), a telephone, a video system, a cellular telephone, a Personal Digital Assistant (PDA), a tablet device, a notebook device, a smartphone, a server 120, and/or the like. As shown in FIG. 1, any number of communication devices 101A-101N may be connected to the network 110, including only a single communication device 101.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network 110 configured to carry messages via packets and/or circuit switched communications.

The server 120 may be any type of server 120 that can host a database 122/123, such as, an application server, a web server, a database server, a development server, and/or the like. The server 120 may comprise multiple servers 120. For example, the server 120 may comprise multiple nodes that support a distributed and/or replicated database 122/123. The server 120 may comprise a cloud service that supports multiple tenants. In one embodiment, the sandbox database(s) 123 may reside on a different server(s) 120 than the main database 122.

The server 120 further comprises application(s) 121, the main database 122, one or more sandbox databases 123, and a sandbox database manager 124. The application(s) 121 are any type of application 121 that uses the databases 122/123, such as, a web application, a financial application, a security application, a human resource application, a social network application, a networked application, and/or the like.

The main database 122 may be any type of database, such as, an objected oriented database, a distributed database, a replicated database, a hierarchical database, a relational database, a network database, a NoSQL database, an analytical database (e.g., Opentext's Vertica™), and/or the like.

The sandbox database(s) 123 are a specific type of database that is created from the main database 122. The sandbox database(s) 123 may be used for various purposes, such as, report/isolation, new research and development versions, for upgrade testing, and/or any environment where a test/separate environment is needed.

The sandbox database manager 124 can be any hardware coupled with software that can manage the creation, configuration, synchronization, and deletion of the sandbox database(s) 123. The sandbox database manager 124 further comprises rules 125. The rules 125 are used to define how the sandbox databases 123 will be managed, created, configured, synchronized, deleted and/or the like.

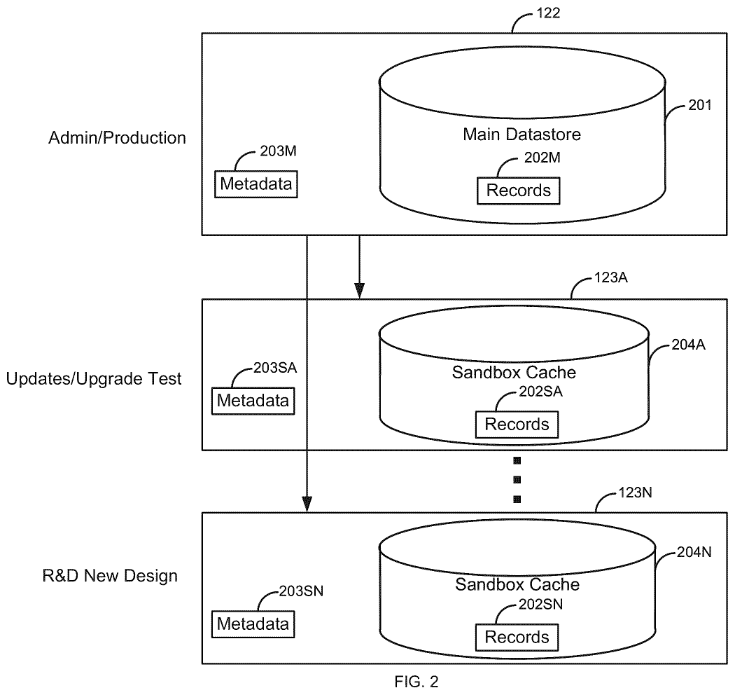

FIG. 2 is a block diagram of a second illustrative system 200 that shows multiple sandbox databases 123A-123N being created for different purposes using a non-distributed main database 122. The second illustrative system 200 comprises the main database 122 and the sandbox databases 123A-123N. In FIG. 2, the main database 122 is a main production database 122. For example, the main database 122 may be a production website for a corporation. In this embodiment, the main database 122 is a non-distributed/non-replicated database 122. For example, the main database 122 may be a relational database that resides only on the server 120. The main database 122 comprises a main datastore 201 and metadata 203M. The metadata 203M is used to identify the records 202M in the main datastore 201. The main datastore 201 contains records 202M (e.g., records 202 in a database table).

The sandbox database 123A comprises a sandbox cache 204A and metadata 203SA. The sandbox cache 204A comprises records 202SA. The sandbox database 123N comprises a sandbox cache 204N and metadata 203SN. The sandbox cache 204N comprises records 202SN.

A sandbox database 123 is typically created as a test database to isolate it from the main database 122. The sandbox cache 204 is a temporary cache that stores records 202 that are copied from the main database 122. What records 202/metadata 203 is copied into the sandbox cache 204 is determined based on different rules 125. The records 202/metadata 203 that are copied into the sandbox database 123 may be different in each of the sandbox databases 123A-123N based on different rules 125 used to create the sandbox databases 123A-123N. For example, the sandbox database 123A may be initially created with only the metadata 203SA (i.e., without the records 202SA). The metadata 203SA may comprise all the metadata 203M of the main database 122 or only a portion of the metadata 203M. Where only the metadata 203SA is initially copied into the sandbox database 123A, individual records 202M from the main database 122 are copied into the sandbox cache 204A based on requests to access the individual records 202 (e.g., reads and/or writes) using the metadata 203SA. Alternatively, based on the rules 125, a subset (or could be all if needed) of the records 202M are initially copied into the sandbox cache 204A/records 202SA. In this example, if other individual records 202 need to be copied from the records 202M (e.g., a read request), the other individual records 202 are copied into the records 202SA.

A similar process may be used to create the sandbox database 123N. For example, based on the rules 125 (e.g., the rules 125 for the R&D new design), a specific set of records 202SN/metadata 203SN are copied into the sandbox database 123N.

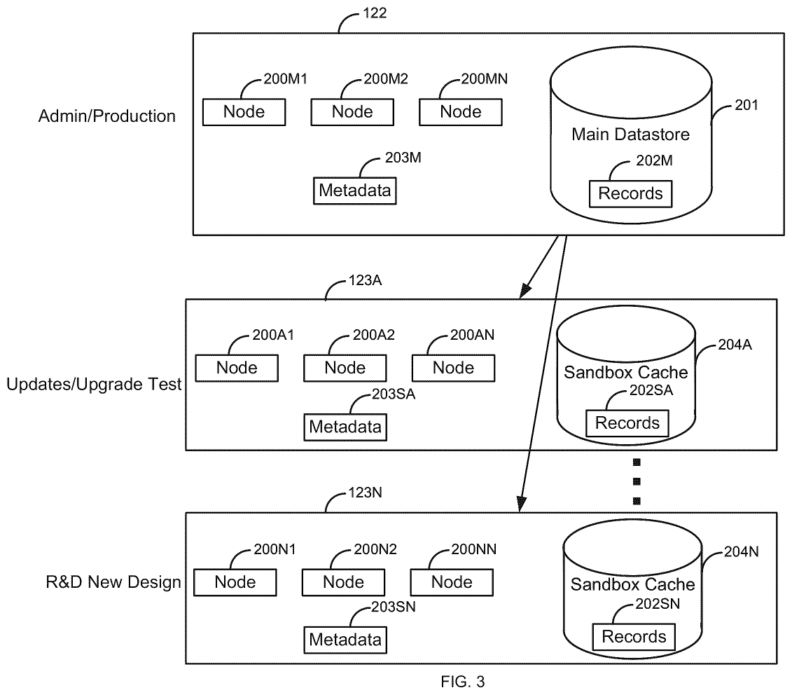

FIG. 3 is a block diagram that shows multiple sandbox databases 123A-123N being created for different purposes where the main database 122 is a replicated database (e.g., Opentext's Vertica™ database). In FIG. 3, the main database 122 is a distributed database that comprises nodes 200M1-200MN, a main datastore 201, and metadata 203M. The nodes 200M1-200MN are different nodes/devices that store the replicas of the records 202M of the main datastore 201. The main datastore 201 contains all the records 202M in the main database 122 (or may be distributed between the nodes 200M1-200MN). In this example, the main datastore 201 resides across the nodes 200M1-200MN. The metadata 203M may be in the main datastore 201 and/or distributed across the nodes 200M1-200MN in a similar manner to the records 202M.

When a sandbox database 123A-123N is created where the main database 122 is a distributed/replicated database, based on the rules 125, a similar process is used like described in FIG. 2. The main difference between FIG. 2 and FIG. 3 is that the nodes 200 are replicated in FIG. 3. In one embodiment, based on the rules 125, a different number of nodes 200M1-200MN are replicated when creating a new sandbox database 123. For example, the main database 122 may have ten nodes 200 (where N is 10), the sandbox database 123A may only have three nodes 200A1-200AN (wherein N is 3), and the sandbox database 123N may have twelve nodes 200 (when N is 12). In addition, the number of nodes 200 may be dynamically reconfigured (i.e., increased or decreased) after the sandbox database 123 has been created.

In one embodiment, the process of FIGS. 2-3 may include synchronizing changes back to the main datastore 201. For example, the changes to the records 202SA in the sandbox cache 204A may be synchronized back to the main datastore 201/record(s) 202M. This can include any new record(s) 202SA that are added to the sandbox cache 204A.

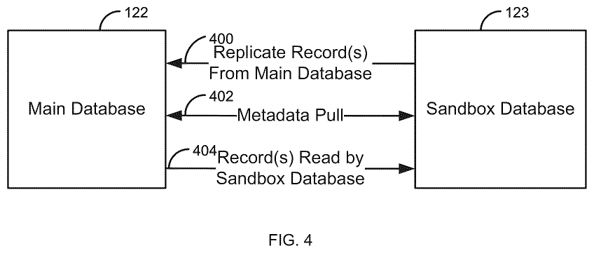

FIG. 4 is a flow diagram of a process for replicating records 202M from a main database 122 to a sandbox database 123 based on a request from the sandbox database 123 using a metadata pull. Illustratively, the communication devices 101A-101N, the network 110, the server 120, the application(s) 121, the main database 122, the sandbox database(s) 123, the sandbox database manger 124, the rules 125, the main datastore 201, and the sandbox caches 204A-202N are stored-program-controlled entities, such as a computer or microprocessor, which performs the method of FIGS. 4-8 and the processes described herein by executing program instructions stored in a computer readable storage medium, such as a memory (i.e., a computer memory, a hard disk, and/or the like). Although the methods described in FIGS. 4-8 are shown in a specific order, one of skill in the art would recognize that the steps in FIGS. 4-8 may be implemented in different orders and/or be implemented in a multi-threaded environment. Moreover, various steps may be omitted or added based on implementation.

The process starts in step 400 when the sandbox database 123 makes a request to replicate one or more records 202M from the main database 122. The sandbox database 123 makes a metadata pull request and the metadata 203M (or a portion of the metadata 203M) is pulled to the sandbox database 123 in step 402. One or more records 202M are then read by the sandbox database 123 in step 404 (based on the request of step 400).

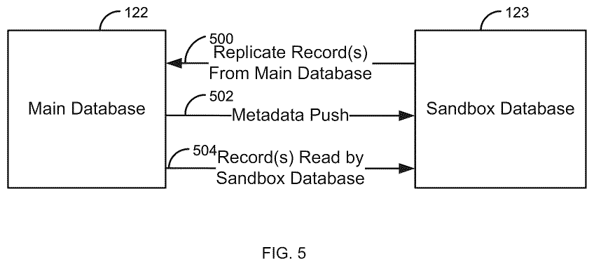

FIG. 5 is a flow diagram of a process for replicating records 202M from a main database 122 to a sandbox database 123 based on a request from the sandbox database 123 using a metadata push. The sandbox database 123 makes a request to replicate one or more records 202 from the main database 122 to the sandbox database 123 in step 500. The main database 122 pushes the metadata 203M (or a subset of the metadata 203M) to the sandbox database 123 in step 502. The one or more records 202M are sent to the sandbox database 123 from the main database 122 in step 504.

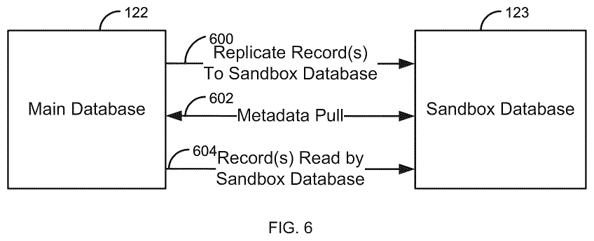

FIG. 6 is a flow diagram of a process for replicating records 202M from a main database 122 to a sandbox database 123 based on a request from the main database 122 using a metadata pull. The main database 122 makes a request to replicate one or more records 202 from the sandbox database 123 in step 600. The sandbox database 123 pulls the metadata 203M (or a subset of the metadata 203M) to the sandbox database 123 in step 602. The one or more records 202M are sent to the sandbox database 123 from the main database 122 in step 504 (based on the request of step 500).

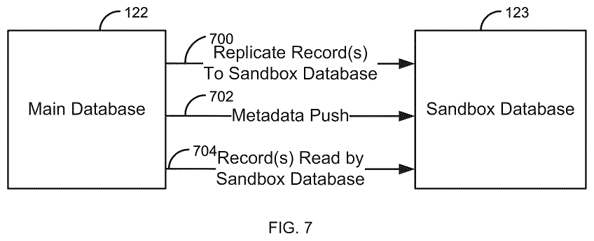

FIG. 7 is a flow diagram of a process for replicating records 202M from a main database 122 to a sandbox database 123 based on a request from the main database 122 using a metadata push. The main database 122 makes a request to replicate one or more records 202 from the main database 122 to the sandbox database 123 in step 700. The main database 122 pushes the metadata 203M (or a subset of the metadata 203M) to the sandbox database 123 in step 702. The one or more records 202M are sent to the main database 122 to the sandbox database 123 in step 704 (based on the request of step 700).

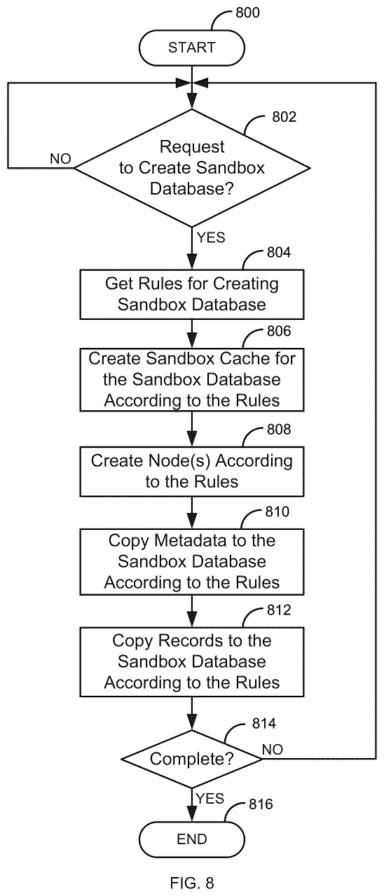

FIG. 8 is a flow diagram of a process for creating a sandbox database 123. The process starts in step 800. The sandbox database manager 124 waits, in step 802, for a request to create a sandbox database 123. If a request to create a sandbox database 123 has not been received in step 802, the process of step 802 repeats.

Otherwise, if a request to create the sandbox database 123 has been received in step 802, the sandbox database manager 124 gets the rule(s) 125 for creating the sandbox database 123 in step 804. The rules 125 may be administered, provided by a user when requesting to create the sandbox database 123, and/or the like.

The sandbox database manager 124 creates a sandbox cache 204 for the sandbox database 123 according to the rules 125 in step 806. The sandbox database manager 124 creates the node(s) 200 (if it is a replicated database), in step 808, according to the rules 125. The sandbox database manager 124 copies the metadata 203 to the sandbox database 123 according to the rules 125 in step 810. The sandbox database manager 124 copies the record(s) 202 to the sandbox database 123 according to the rules 125 in step 812. Although step 812 is shown in series, step 812 may be a separate thread that copies the record(s) 202 to the sandbox database 123 based on reads and/or writes. For example, the sandbox cache 204 may not initially have any records 202. The separate thread then populates the sandbox cache 204 for each read/write request.

The sandbox database manager 124 determines, in step 814, if the process is complete. If the process is not complete in step 814, the process goes back to step 802. Otherwise, if the process is complete in step 814, the process ends in step 816.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
create a first sandbox database, wherein creating the first sandbox database comprises:
creating a first sandbox cache in the first sandbox database; and
copying metadata from a main database to the first sandbox database.

2. The system of claim 1, wherein the microprocessor readable and executable instructions further cause the microprocessor to:
copy records associated with the metadata, wherein the copied records are stored in the first sandbox cache and wherein the copied records are stored in the first sandbox cache based on one of:
a rule associated with the creating of the first sandbox database;
based on a read request using the metadata; and
based on a write request using the metadata.

3. The system of claim 1, wherein the metadata is a first subset of metadata from the main database.

4. The system of claim 1, wherein the first sandbox database comprises a plurality of sandbox databases and wherein the first sandbox database is one of the plurality of sandbox databases.

5. The system of claim 4, wherein the first sandbox database of the plurality of sandbox databases uses a first subset of metadata from the main database, wherein a second sandbox database of the plurality of sandbox databases uses a second subset of metadata from the main database, and wherein the first subset of metadata and the second subset of metadata are different.

6. The system of claim 1, wherein the first sandbox cache stores any changes to records in the first sandbox cache and wherein the changes to the records stored in the first sandbox cache are used to synchronize the changes in the records back to the main database.

7. The system of claim 1, wherein records are sent from the main database in at least one of the following ways:
based on a request from the sandbox database that uses a metadata pull;
based on a request from the sandbox database that uses a metadata push;
based on a request from the main database that uses a metadata pull; and
based on a request from the main database that uses a metadata push.

8. The system of claim 1, wherein the microprocessor readable and executable instructions further comprise:
receiving an input identifying a number of nodes in the first sandbox; and
creating the number of nodes in the first sandbox, wherein the number of nodes in the first sandbox is different from a number of nodes in the main database.

9. A method comprising:
creating, by a microprocessor, a first sandbox database, wherein creating the first sandbox database comprises:
creating, by the microprocessor, a first sandbox cache in the first sandbox database; and
copying, by the microprocessor, metadata from a main database to the first sandbox database.

10. The method of claim 9, further comprising:
copying records associated with the metadata, wherein the copied records are stored in the first sandbox cache and wherein the copied records are stored in the first sandbox cache based on one of:
a rule associated with the creating of the first sandbox database;
based on a read request using the metadata; and
based on a write request using the metadata.

11. The method of claim 9, wherein the metadata is a first subset of metadata from the main database.

12. The method of claim 9, wherein the first sandbox database comprises a plurality of sandbox databases and wherein the first sandbox database is one of the plurality of sandbox databases.

13. The method of claim 12, wherein the first sandbox database of the plurality of sandbox databases uses a first subset of metadata from the main database, wherein a second sandbox database of the plurality of sandbox databases uses a second subset of metadata from the main database, and wherein the first subset of metadata and the second subset of metadata are different.

14. The method of claim 9, wherein the first sandbox cache stores any changes to records in the first sandbox cache and wherein the changes to the records stored in the first sandbox cache are used to synchronize the changes in the records back to the main database.

15. The method of claim 9, wherein records are sent from the main database in at least one of the following ways:
based on a request from the sandbox database that uses a metadata pull;
based on a request from the sandbox database that uses a metadata push;
based on a request from the main database that uses a metadata pull; and
based on a request from the main database that uses a metadata push.

16. The method of claim 9, wherein the microprocessor readable and executable instructions further comprise:
receiving an input identifying a number of nodes in the first sandbox; and
creating the number of nodes in the first sandbox, wherein the number of nodes in the first sandbox is different from a number of nodes in the main database.

17. A non-transient computer readable medium having stored thereon instructions that cause a microprocessor to execute a method, the method comprising instructions to:
create a first sandbox database, wherein creating the first sandbox database comprises:
creating a first sandbox cache in the first sandbox database; and
copying metadata from a main database to the first sandbox database.

18. The non-transient computer readable medium of claim 17, the instructions further cause the microprocessor to:
copy records associated with the metadata, wherein the copied records are stored in the first sandbox cache and wherein the copied records are stored in the first sandbox cache based on one of:
a rule associated with the creating of the first sandbox database;
based on a read request using the metadata; and
based on a write request using the metadata.

19. The non-transient computer readable medium of claim 17, wherein first sandbox database comprises a plurality of sandbox databases and wherein the first sandbox database is one of the plurality of sandbox databases.

20. The non-transient computer readable medium of claim 17, wherein the microprocessor readable and executable instructions further comprise:
receiving an input identifying a number of nodes in the first sandbox; and
creating the number of nodes in the first sandbox, wherein the number of nodes in the first sandbox is different from a number of nodes in the main database.
